(19) United States
(12) Patent Application Publication
(10) Pub. No.: US 2006/0174026 A1
(43) Pub. Date: Aug. 3, 2006

(54) System and method for a remote user interface

(76) Inventors: Aaron Robinson, San Diego, CA (US); Roland Osborne, Walnut Creek, CA (US); Brian Fudge, San Diego, CA (US)

Correspondence Address: CHRISTIE, PARKER & HALE, LLP, PO BOX 7068, PASADENA, CA, 91109-7068, US

(21) Appl. No.: 11/323,044

(22) Filed: Dec. 30, 2005

Related U.S. Application Data
(63) Continuation-in-part of application No. 11/198,142, filed on Aug. 4, 2005.
(60) Provisional application No. 60/642,265, filed on Jan. 5, 2005.

(51) Int. Cl. G06F 15/16

(52) U.S. Cl. 709/231

(57) ABSTRACT

A remote user interface provides a full motion, full-color, dynamic interface with complex visuals without imposing heavy hardware requirements on a consumer electronics device. Instead, the hardware requirements are placed on another computer device that is designated as a media server. The media server generates the complex UI, encodes the UI into one or more compressed video frames, and transmits the compressed video frames to the CE device. The CE device plays the UI video as it would any other video. User inputs for interacting with the UI are transmitted and interpreted by the media server. The media server updates the UI images based on the interaction.

### CROSS-REFERENCE TO RELATED APPLICATION(S)

This application claims the benefit of U.S. Provisional Application No.

60/642,265, filed Jan. 5, 2005, and is a continuation-in-part of U.S. application Ser. No. 11/198,142, filed on Aug. 4, 2005 (attorney docket 55366/DJB/D579), the content of both of which are incorporated herein by reference.

This application also contains subject matter that is related to the subject matter disclosed in U.S. patent application entitled “Improved Media Transfer Protocol” (attorney docket 56420/JEC/D579), and the subject matter disclosed in U.S. patent application entitled “Interactive Multichannel Data Distribution System” (attorney docket 56575/DJB/D579), both submitted on the same day as this application, the content of both of which are incorporated herein by reference. This application also contains subject matter that is related to the subject matter disclosed in PCT patent application No. US04/41,667 entitled “Multimedia Distribution System,” filed on Dec. 8, 2004 (attorney docket 53513P/DJB/D579), the content of which is also incorporated herein by reference.

### FIELD OF THE INVENTION

This invention relates generally to remote user interfaces, and more specifically, to a remote user interface displayed on a consumer electronics device.

### BACKGROUND OF THE INVENTION

There is an increasing trend in using consumer electronic (CE) devices such as, for example, televisions, portable media players, personal digital assistants (PDAS), and the like, for acquiring, viewing, and managing digital media. Typical digital media may include photos, music, videos, and the like. Consumers want to conveniently enjoy the digital media content with their CE devices regardless of the storage of the media across different devices, and the location of such devices in the home.

In order to allow a user to acquire, view, and manage digital media, the CE device is equipped with a user interface (UI) with which the user can interact. Currently existing user interfaces are generally limited to computer-generated JPEG or BMP displays. Such computer-generated images, however, are restricted in the type of visuals, motions, and effects that they can provide.

Also, in the prior art, the user interface displayed on the CE device is generated by the CE device itself. This requires that the generating CE device be equipped with the necessary UI browser, font libraries, and rendering capabilities, as demanded by the type of user interface that is to be provided. Thus, the type of display that may be displayed is limited by the processing capabilities of the CE device. The richer the user interface that is to be provided, the heavier the processing requirements on the CE device.

Accordingly, what is needed is a CE device that provides a rich user interface without imposing heavy processing requirements on the CE device.

### SUMMARY OF THE INVENTION

The various embodiments of the present invention are directed to generating a rich UI on a remote device. The remote UI according to these various embodiments provides a full motion, full-color, dynamic interface with complex visuals without imposing heavy hardware requirements on the CE device. Instead, the hardware requirements are placed on another computer device that is designated as a media server. The media server generates the complex UI, transforms the UI into a compressed video format, and transmits the compressed video to the CE device. Thus, the CE device may be kept relatively simple, allowing for a cost-efficient CE device.

According to one embodiment, the present invention is directed to a method for a remote user interface in a data communications network including a client device coupled to a server, where the method includes retrieving a first graphics-based image from a data store; encoding the first graphics-based image into a compressed video frame; streaming the compressed video frame to the client device, the client device being configured to uncompress and play the video frame; receiving a control event from the client device; and retrieving a second graphics-based image from the data store based on the received control event.

According to another embodiment, the present invention is directed to a method for a remote user interface in a data communications network including a client device coupled to a server, where the method includes decoding and uncompressing one or more compressed first video frames received from the server; playing first video contained in the one or more first video frames, the first video providing one or more user interface images; receiving user input data responsive to the one or more user interface images; generating a control event based on the user input data; transmitting the control event to the server; and receiving from the server one or more compressed second video frames responsive to the transmitted control event, the one or more compressed second video frames containing updated one or more user interface images.

According to another embodiment, the present invention is directed to a server providing a remote user interface on a client device coupled to the server over a wired or wireless data communications network. The server includes a frame buffer storing a first graphics-based image, a video encoder encoding the first graphics-based image into a compressed video frame, and a processor coupled to the video encoder and the frame buffer. The processor streams the compressed video frame to the client device, and the client device is configured to uncompress and play the video frame. The processor receives a control event from the client device and retrieves a second graphics-based image from the frame buffer based on the received control event.

According to one embodiment of the invention, the server includes a graphics processing unit coupled to the frame buffer that generates the first graphics-based image. The graphics processing unit also updates the first graphics-based image based on the control event and stores the updated first graphics-based image in the frame buffer as the second graphics-based image.

According to one embodiment of the invention, the server includes a dedicated video transfer channel interface for streaming the compressed video frame to the client device, and a dedicated control channel interface for receiving the control event from the client device.

According to another embodiment, the present invention is directed to a client device coupled to the server over a wired or wireless data communications network for providing a user interface. The client device includes a video decoder decoding and uncompressing one or more compressed first video frames received from the server; a display coupled to the video decoder for displaying first video contained in the one or more first video frames, the first video providing one or more user interface images; a user input providing user input data responsive to the one or more user interface images; and a processor coupled to the user input for generating a control event based on the user input data and transmitting the control event to the server, the processor receiving from the server one or more compressed second video frames containing updated one or more user interface images.

According to one embodiment, the one or more user interface images are images of interactive menu pages, and the user input data is for a user selection of a menu item on a particular menu page.

According to another embodiment of the invention, the graphics-based image is an interactive computer game scene, and the user input data is for a user selection of a game object in the computer game scene.

According to a further embodiment of the invention, the graphics-based image is an interactive web page, and the user input data is for a user selection of a link on the web page.

According to one embodiment, the client device includes a video transfer channel interface for receiving the one or more compressed first and second video frames, and a dedicated control channel interface for transmitting the control event.

According to one embodiment of the invention, the dedicated video transfer channel interface receives media encrypted with an encryption key, and the client device is programmed to obtain a decryption key for decrypting and playing the encrypted media.

These and other features, aspects and advantages of the present invention will be more fully understood when considered with respect to the following detailed description and accompanying drawings.

### BRIEF DESCRIPTION OF THE DRAWINGS

FIG. 1 is a block diagram of a system for providing a rich remote UI on one or more CE devices according to one embodiment of the invention;

FIG. 2 is a schematic block diagram illustrating communication between a media server and a client according to one embodiment of the invention;

FIG. 3 is a more detailed block diagram of the media server of FIG. 2 according to one embodiment of the invention;

FIG. 4 is a more detailed block diagram of the client of FIG. 2 according to one embodiment of the invention;

FIG. 5 is a flow diagram of a process for setting up a media server and a client CE device according to one embodiment of the invention;

FIG. 6 is an exemplary block diagram of an exemplary UI event packet transmitted to a media server according to one embodiment of the invention;

FIG. 7 is an exemplary block diagram of a data packet for transmitting a UI video as well as other types of media data according to one embodiment of the invention; and

FIGS. 8A and 8B are respectively a flow diagram and a schematic block diagram illustrating the generating and/or updating of a remote UI displayed on a client according to one embodiment of the invention.

### DETAILED DESCRIPTION

In general terms, the various embodiments of the present invention are directed to generating a rich UI on a remote device. The term UI is used herein to refer to any type of interface provided by a computer program to interact with a user. The computer program may provide, for example, menus, icons, and links for selection by a user. The computer program may also be a browser program providing a web page with hyperlinks and other user selectable fields. The computer program may further take the form of a computer game providing different game objects within a computer game scene for manipulation by the user.

Regardless of the type of UI, the UI according to these various embodiments provides a full motion, full-color, dynamic interface with complex visuals without imposing heavy hardware requirements on the CE device. Instead, the hardware requirements are placed on another computer device that is designated as a media server. The media server generates the complex UI, encodes the UI into one or more compressed video frames, and transmits the compressed video frames to the CE device. Thus, the CE device may be kept relatively simple, minimizing the costs in manufacturing the CE device.

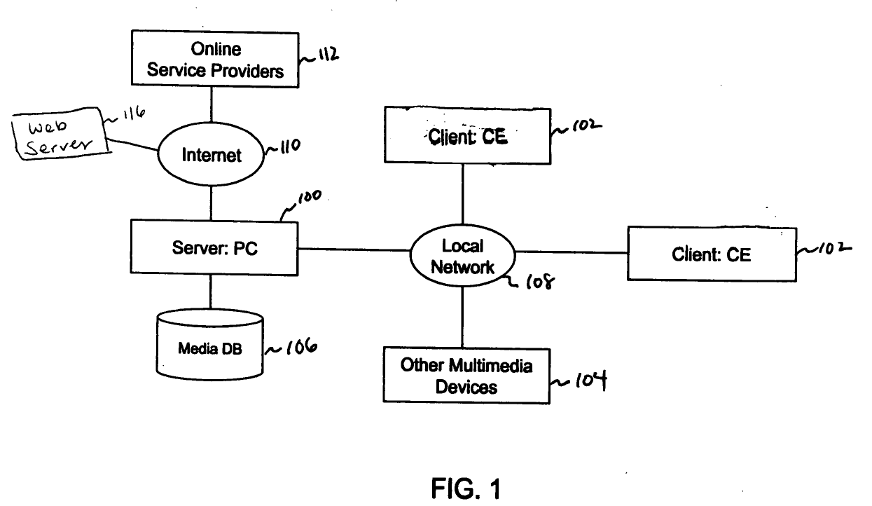

FIG. 1 is a block diagram of a system for providing a rich remote UI on one or more CE devices according to one embodiment of the invention. The system includes a media server 100 coupled to one or more client CE devices 102 over a data communications network 108. According to one embodiment of the invention, the data communications network 108 is a local area network, a local wide area network, or a wireless local area network. The media server 100 may also be coupled to a public data communications network 110 such as, for example, the Internet, for connecting the CE devices 102 to various online service providers 112 and web servers 116.

According to another embodiment of the invention, the CE device communicates with the media server 100 over a wide area wireless network or any other type of network conventional in the art, such as, for example, the Internet. The media server may be on the same or different network than the online service providers 112. In fact, the media server may be incorporated into a computer providing online services for a particular online service provider 112.

The media server 100 may take the form of any networked device having a processor and associated memory for running a media server program. As such, the media server 100 may be a personal computer, laptop computer, set-top box, digital video recorder, stereo or home theater system, broadcast tuner, video or image capture device (e.g. a camera or camcorder), multimedia mobile phone, Internet server, or the like.

The client 102 may take the form of any networked CE device configured with the necessary peripherals, hardware, and software for accepting user input data and rendering audio, video, and overlay images. Exemplary CE devices include, but are not limited to, TV monitors, DVD players, PDAs, portable media players, multimedia mobile phones, wireless monitors, game consoles, digital media adaptors, and the like.

The media server 100 provides to the clients 102 a rich UI video as well as other types of media for playing by the client 102. The media provided by the media server 100 may be media that is stored in its local media database 106 and/or media stored in other multimedia devices 104, online service providers 112, or web servers 116.

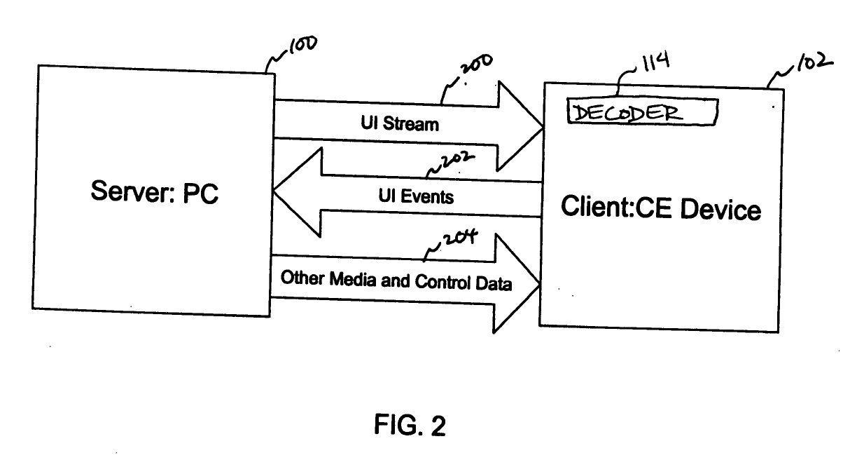

FIG. 2 is a schematic block diagram illustrating communication between the media server 100 and a particular client 102 according to one embodiment of the invention. In the illustrated embodiment, the media server 100 exchanges various types of media data and control information 204 with the client 102, such as, for example, video, music, pictures, image overlays, and the like. In the case of video, it is typically sent to the client 102 in a compressed format. Accordingly, client 102 includes one or more video decoders 114 that decode and uncompress compressed video received from the media server 100. The media server 100 also generates a graphical UI image, transforms the UI image into a compressed video format, and transmits the video to the client 102 as a UI video stream 200.

The UI provided to a CE device often uses more motion, overlays, background images, and/or special effects than traditional computer-type UIs. An example of a UI that may be provided by a CE device is a DVD menu. Due to the enhanced visuals displayed on a CE device, traditional compression mechanisms used for compressing computer-type UIs are not adequate for compressing UIs provided to the CE device. However, traditional video compression mechanisms used for compressing motion video, such as those utilized by video decoders 114, are also suited for compressing UIs provided to the CE device. Accordingly, such video compression mechanisms are utilized for compressing UIs provided to the CE device and video decoders 114 are used to decode and uncompress the video encoded UI images. Such video compression mechanisms include, for example, H.264, MPEG (including MPEG-1, MPEG-2, MPEG-4), and other specialized implementations of MPEG, such as, for example, DivX.

DivX is a video codec which is based on the MPEG-4compression format. DivX compresses video from virtually any source to a size that is transportable over the Internet without significantly reducing the original video's visual quality. The various versions of DivX includes DivX 3.xx, DivX 4.xx, DivX 5.xx, and DivX 6.xx.

The user of the client CE device 102 receives the UI video compressed using any of the above video compression mechanisms, and generates UI events 202 in response. The UI events 202 are transmitted to the media server 100 for processing and interpreting by the server instead of the client itself. The offloading of the processing requirements to the server instead of maintaining it in the client allows for a thin client without compromising the type of user interface provided to the end user.

Exemplary UI events are keypress selections made on a remote controller in response to a displayed UI menu. The keypress data is transmitted to the media server 100 as a UI event, and in response, the media server 100 interprets the keypress data and updates and retransmits a UI frame to the client to reflect the keypress selection.

According to one embodiment of the invention, the UI events 202 are cryptographically processed utilizing any one of various encryption and/or authentication mechanisms known in the art. Such cryptographic processing helps prevent unauthorized CE devices from receiving media and other related information and services from the media server 100.

According to one embodiment of the invention, separate media transfer connections are established between the media server 100 and client 102 for the transfer of the UI stream 200, the receipt of the UI events 202, and for engaging in other types of media transport and control 204. An improved media transfer protocol, such as, for example, the improved media transfer protocol described in the U.S. patent application entitled “Improved Media Transfer Protocol,” may be used to exchange data over the established media transfer connections. According to this improved media transfer protocol, the UI stream 200 is transmitted over a video connection, and the UI events 202 over a control connection. An audio connection, image overlay connection, and out-of-band connection may also be separately established for engaging in the other types of media transport and control 204, as is described in further detail in the application entitled “Improved Media Transfer Protocol.” For example, the out-of-band channel may be used to exchange data for re-synchronizing the media position of the server in response to trick play manipulations such as, for example, fast forward, rewind, pause, and jump manipulations, by a user of the client CE device. The separate audio and overlay channels may be respectively used for transmitting audio and image overlay data from the server 100 to the client 102.

The use of the separate media transfer channels to transmit different types of media allows the media to be transmitted according to their individual data transfer rates. Furthermore, the improved media transfer protocol provides for a streaming mode which allows the client to render each type of media immediately upon receipt, without dealing with fine synchronization issues. Thus, the UI video may be displayed along with background music and image overlay data without requiring synchronization of such data with the UI video.

Although it is contemplated that the UI video stream 200 will be transmitted over a dedicated video transfer channel via a video transfer channel interface, the UI events 202 over a dedicated control channel via a dedicated control channel interface, and the other types of media over their dedicated media transfer channels via their respective interfaces, a person of skill in the art should recognize that the UI video stream may be interleaved with other types of media data, such as, for example, audio and/or overlay data, over a single data transfer channel.

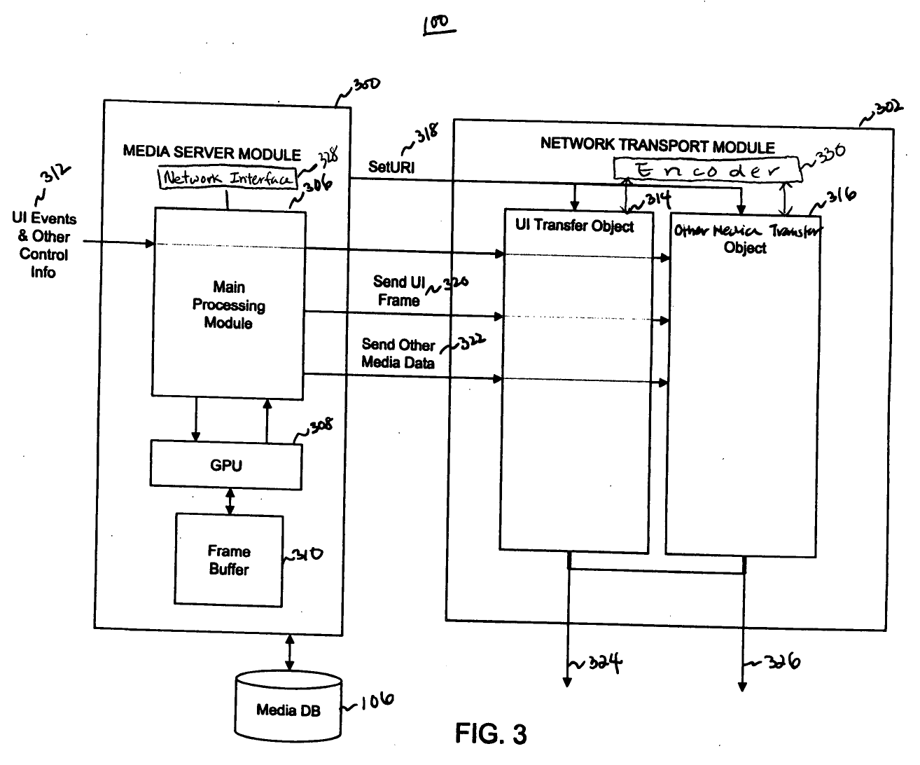

FIG. 3 is a more detailed block diagram of the media server 100 according to one embodiment of the invention. The media server 100 includes a media server module 300 in communication with a network transport module 302 and the media database 106. The media server module 300 may interface with the network transport module 302 over an application program interface (API).

The media server module 300 includes a main processing module 306 coupled to a graphics processing unit (GPU) 308, and a frame buffer 310. The main processing module 306 further includes a network interface 328 for communicating with the Web servers 116 and online service providers 112 over the public data communications network 110.

The main processing module 306, receives UI events and other control information 312, processes/interprets the information, and generates appropriate commands for the network transport module to transfer appropriate media to the client 102.

If the media to be transferred is a UI, the main processing module 306 invokes the GPU 308 to generate a graphical image of the UI. The GPU takes conventional steps in generating the graphical image, such as, for example, loading the necessary textures, making the necessary transformations, rasterizing, and the like. The generated graphical image is then stored in a frame buffer 310 until transferred to the network transport module 302.

According to one embodiment of the invention, the graphical image may be retrieved from a local or remote source. For example, if the UI takes the form of a web page, the particular web page that is to be displayed is retrieved from the web server 116 via the network interface 328.

The network transport module 302 may be implemented via any mechanism conventional in the art, such as, for example, as a software module executed by the main processing module 306. The network transport module includes encoding capabilities provided by one or more encoders 330, such as, for example, a video encoder, for generating appropriate media transfer objects to transfer the media received from the media server module 300. In this regard, a UI transfer object 314 is generated to transmit a UI and associated media to the client 102 in an UI mode. Other media transfer object(s) 316 may also be generated to transmit different types of media in a non-UI mode.

The network transport module generates the appropriate media transfer object in response to a command 318 transmitted by the main processing module 306. According to one embodiment of the invention, the command 318 includes a media type and a path to the media that is to be transferred. The path to the media may be identified by a uniform resource identifier (URI).

The network transport module 302 creates the appropriate media transfer object in response to the received command 318, such as, for example, the UI transfer object 314. Media data is then sent to the generated media transfer object using appropriate API commands. For example, a UI frame stored in the frame buffer 310 may be sent to the UI transfer object 314 via a “send UI frame” command 320. Other media data 322 may also be sent to the generated transfer object via their appropriate API commands. For example, background music and overlay data may be sent to the UI transfer object 314 for transmitting to the client with the UI video stream. According to one embodiment of the invention, the UI video and other types of media transmitted with the UI video are each transmitted via a separate media transfer channel in an asynchronous streaming mode.

The generated transfer block 314 or 316 receives the media data from the media server module 300 and generates appropriate media data packets in response. In doing so, the media transfer block generates and attaches the appropriate headers to the media data packets. The packets are then transmitted to the client over one or more data transfer channels 324, 326.

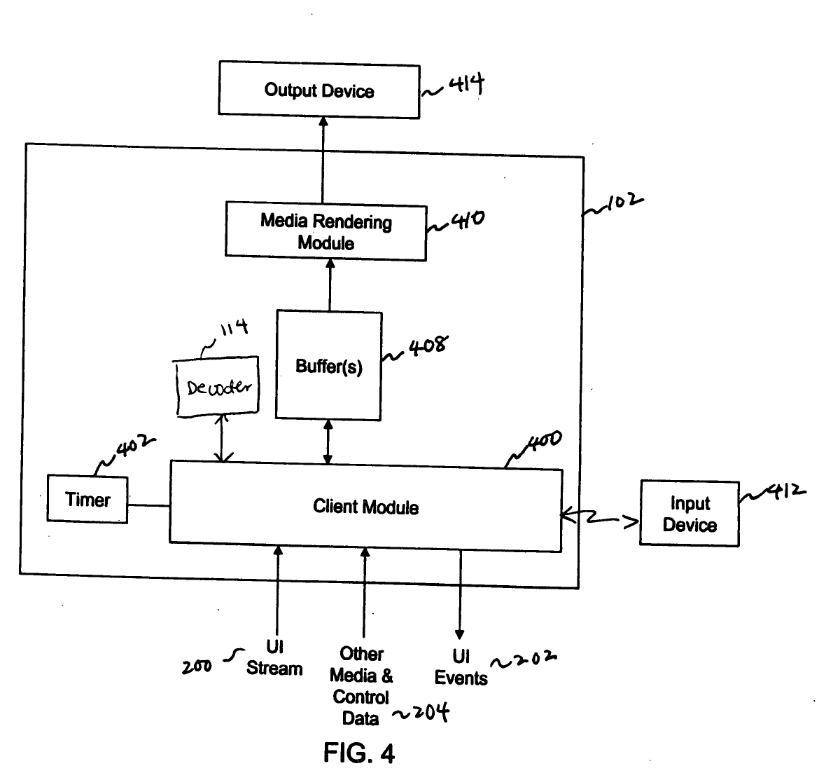

FIG. 4 is a more detailed block diagram of the client 102 receiving the UI video and other types of media data packets from the media server 100 according to one embodiment of the invention. The client 102 includes a client module 400 configured to receive the UI video stream 200 and the other types of media data and control information 204 from the media server 100. The client module 400 may be implemented via any mechanism conventional in the art, such as, for example, as a software module executed by a microprocessor unit hosted by the client 102.

The client module 400 forwards the received packets to one or more data buffers 408. The one or more data buffers 408 are emptied at a rate in which a media rending module 410 renders the data stored in the buffers to an output device 414. If a packet is a stream packet, the data is decoded and uncompressed by the video decoder 114 and rendered by the media rendering module as soon as its rendering is possible. If a packet is a time-stamped packet, the data is rendered after the passage of the time specified in the timestamp, as is measured by a timer 402 coupled to the client module 400.

User input selections are provided to the client 102 via a user input device 412 coupled to the client over wired or wireless mechanisms. According to one embodiment of the invention, the input device includes keys (also referred to as buttons) which may be manipulated by a user to invoke particular functionality associated with the keys. The input device may be a remote controller or another input device conventional in the art, such as, for example, a mouse, joystick, sensor, or voice input device.

According to one embodiment of the invention, user input selections are packaged as UI event packets 202 and transferred to the server 100 over a separate control channel for processing by the server. The user input selections may be keypresses for selecting a particular menu item in a menu page, moving an object within a computer game scene, selecting a particular hyperlink on a web page, or the like.

In a typical scenario, a user obtains a client CE device to view different types of media files stored in the media server 100 and in other multimedia devices 104 connected to the network 108. The CE device may further be used to play computer games, browse web pages, and the like. According to one embodiment, included with the CE device is a media server program that the user may install in a computer that he or she would like to designate as the media server 100. Alternatively, the media server program may be downloaded from a remote server or obtained using any other conventional mechanism known in the art.

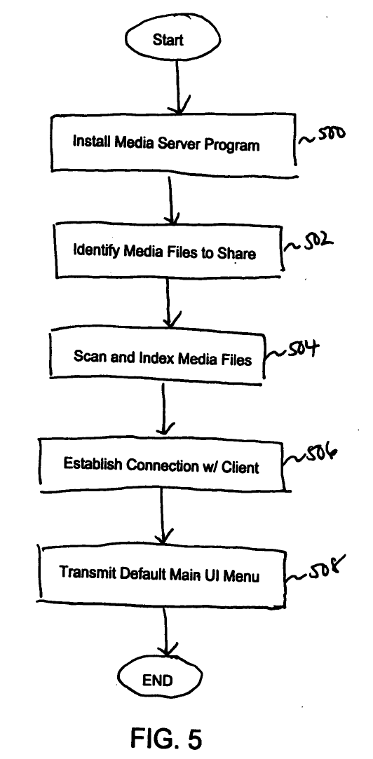

FIG. 5 is a flow diagram of a process for setting up the media server 100 and the client CE device 102 according to one embodiment of the invention. In step 500, the user proceeds to install the media server program for executing by the main processing module 306. The media server program 500 may be installed, for example, on a hard disc or other storage (not shown) included in the media server module 300 and executed, for example, after being loaded in a local memory (not shown) included in the main processing module 306.

Upon installation and launching of the media server program, the user, in step 502, is requested to identify the location of the media files that he or she would like to share with the client 102. Because the media files may be located in the computer device selected as the media server 100 or in any other networked device 104, online service provider 112, or web server 116 accessible to the media server 100, the user may provide local or network paths to the location of the media files that are to be shared. According to one embodiment of the invention, the media files in the other networked devices may be automatically discovered by the media server 100 via, for example, a Content Directory Service included in the well-known Universal Plug and Play (UPnP) industry standard. Once discovered, the user may simply indicate for each media file, whether it is to be shared or not.

In step 504, the main processing module 306 proceeds to scan and index the media files stored in the user-identified locations. According to one embodiment of the invention, the scanning and indexing process occurs in the background, and is invoked each time a new media file is added to any of the media locations identified by the user. During the scanning and indexing process, the main processing module 306 retrieves the metadata information of the media files in the selected media folders, and stores the metadata information in the media database 106. The metadata information may then be used to search for different types of media, render particular UI pages, and the like.

In step 506, a connection is established between the media server 100 and the client 102. The user may set the media server 100 as a default server to which the client may automatically connect upon its power-on. If a specific media server is not identified as the default server, the client attempts to establish a connection with all available media servers. In this regard, the main processing module transmits a discovery request over a predefined port. According to one embodiment, the discovery request is a UDP broadcast packet with a header portion that contains information on an IP address of the client as well as information on a port that the server may use to respond to the discovery request. According to another embodiment, a UPnP SSDP (Simple Service Discovery Protocol) which is conventional in the art, may be used for the discovery of the media server.

An available server receiving the discovery request responds with a discovery reply. According to one embodiment of the invention, the discovery reply is a UDP packet which includes information of a control port that the client may use to establish a control connection. A TPC connection is then established with a desired server over the indicated control port. The control connection may be used to transmit the UI events 202 generated by the client 102 to the media server 100.

According to one embodiment of the invention, the client further sends, over the control port, a packet containing information on one or more other media transfer ports that are available for connection. The responding server may then establish a TCP connection to each available media transfer port. For example, a video connection may be established for transmitting the video UI stream to the client. Other media connections that may be established is an audio connection, overlay connection, and/or out-of-band connection.

Upon the establishing the one or more media connections between the media server 100 and the client 102, the media server 100 proceeds, in step 508, to transmit a default main UI menu over the video connection. The user may then start interacting with the main UI menu for enjoying different types of media via the client CE device 102.

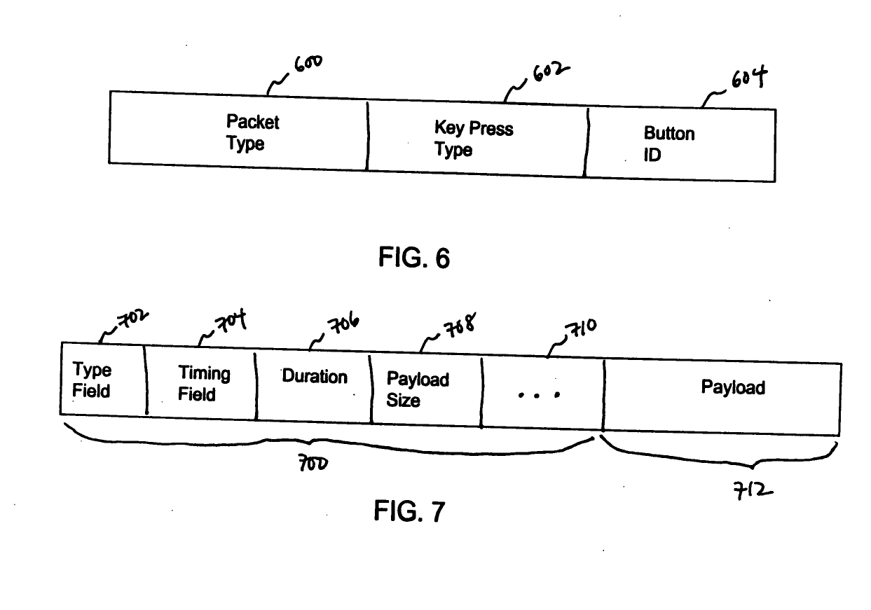

FIG. 6 is an exemplary block diagram of an exemplary UI event packet transmitted to the media server 100 according to one embodiment of the invention. The packet includes a packet type field 600 indicating the type of UI event transmitted by the packet. For example, the UI event may be a keypress event. Keypress event packets include a keypress type field 602 and a button identifier field 604. The keypress type field 602 indicates a button's current state, such as, for example, that the button is in a down, pressed position, or that the button is in an up, unpressed position. The button ID field identifies a particular button that is invoked on the user input device 412, such as, for example, a left, right, select, play, stop, rewind, fast forward, jump, or pause button. Other examples of UI events include, but are not limited to, pointer commands, such as commands describing mouse or touchpad inputs, analog joystick or shuttle inputs, or voice inputs.

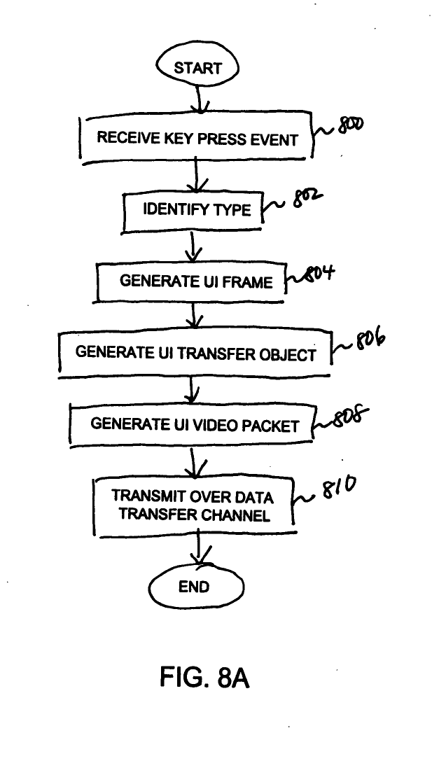

FIG. 7 is an exemplary block diagram of a data packet for transmitting a UI video as well as other types of media data according to one embodiment of the invention. The data packet includes a header portion 700 with a type field 702, timing field 704, duration 706, and payload size 708. Any other conventional fields 710 that may be contained in a typical RTP packet header may also be included in the header portion 700 of the data packet. The actual payload data for the media to be transmitted over the media connection is included in a payload portion 712 of the packet.

The type field 702 indicates the type of media that is being transmitted, such as, for example, a particular type of video (e.g. DivX, AVI, etc.), a particular type of audio (e.g. MP3, AC3, PCM, etc.), or a particular type of image (e.g. JPEG, BMP, etc.).

The timing field 704 indicates how media is to be rendered by the client 102. For example, if the timing field 604 is set to a streaming mode, the media packet is to be rendered by the client 102 as soon as such rendering is possible. If the timing field 604 is set to a timestamp mode, the media packet is to be rendered after the time specified in the timestamp.

The timestamp and stream modes may further be qualified as synchronous or asynchronous. If the timing field 704 indicates a synchronous stream or timestamp mode, the duration field 706 is set to include a duration of time in which the transmitted data is valid. If the timing field 704 indicates an asynchronous stream or timestamp mode, no duration is included in the duration field 706.

Other fields 708 specific to the particular type of media being transmitted may also be included in the header portion 700 of the packet. For example, if the packet is a video packet, information such as the video dimensions may be included in the packet. Similarly, if the packet is an audio packet, information such as the sample rate may be included in the packet.

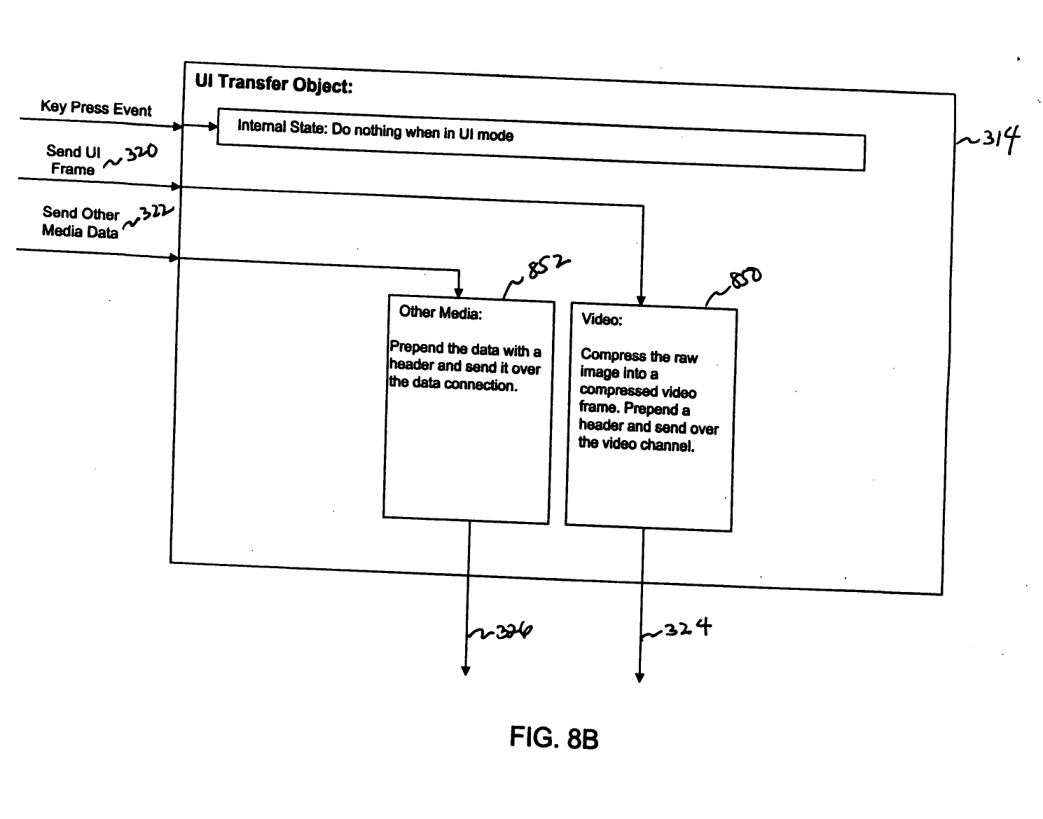

FIGS. 8A and 8B are respectively a flow diagram and a schematic block diagram illustrating the generating and/or updating of a remote UI displayed on the client 102 according to one embodiment of the invention. In step 800, the main processing module 306 in the media server 100 receives a control packet including a key press event. In step 802, the main processing module 306 identifies the type of key press event based on the information contained in the key press type field 602 and button ID field 604 of the received control packet. In step 804, the main processing module 306 invokes the GPU 308 to generate or update a frame of the remote UI in response to the identified key press event. The UI frame is then stored in the frame buffer 310

In step 806, the main processing module 306 transmits to the network transport module 302 a command 318 to generate the UI transfer object 314. The command 318 indicates that the type of media to be transferred is a UI frame, and further includes a reference to the frame buffer 310 including the UI frames to be converted and transferred. In response, the network transport module 302 generates the UI transfer object 314 in step 806.

In step 808, the UI transfer object 314 generates a UI video packet 850 (FIG. 8B) for transmitting to the client 102. Other media packets 852 may also be generated for transmitting to the client 102. For example, the UI transfer object 314 may, generate separate audio and/or overlay packets based on other media data 322 provided by the media server module 300. The audio packets may be associated with background music to be played along with the UI display. Overlay packets may be associated with status bars, navigation icons, and other visuals to be overlaid on top of the UI video. The generating and transmitting of other media packets to be transmitted concurrently with the UI video is described in further detail in the above-referenced U.S. patent application entitled “Improved Media Transfer Protocol.”

In generating the UI video packet 850, the UI transfer object 314 takes a UI frame transmitted by the media server module 300 using the appropriate API command 320. The UI transfer object invokes the encoder 330 to encode the raw image into a compressed video frame such as, for example, a DivX video frame. The creation of such encoded video frames is described in further detail in the above-referenced PCT patent application No. US04/41667. The UI transfer object then prepends the appropriate header data into the header portion 700 of the generated video packet. In doing so, the type field 702 of the data packet is set to an appropriate video type, and the timing field 704 is set to an appropriate timing mode. The generated video packet is then transmitted over the appropriate data transfer channel 324.

According to one embodiment of the invention, the main UI menu provides a videos option, music option, photos option, services option, and settings option. The user may navigate to any of these options by manipulating one or more navigation keys on the input device 412. Upon navigating to the videos option, the media server 200 generates an updated UI with a list of movie files stored in the media database 106 which may be organized by title, filename, group, genre, and the like. The updated UI is transformed into a video format and transmitted to the client for display thereon.

According to one embodiment, the UI may allow the user to view the movies according to different categories. For example, the user may view movies by location if the movies are stored in different devices in the network, by date (e.g. by placing the most recently modified video at the top of the list), or by any other category such as, for example, by title.

The user may navigate to a particular movie listing and hit an “enter” or “play” button to view the movie. The selected movie is retrieved by the media server 100 and streamed to the client for playing in real time. According to one embodiment, the video portion of the movie is streamed over a video connection, and the audio portion of the movie streamed over an audio connection as is described in the U.S. patent application entitled “Improved Media Transfer Protocol.”

While viewing the movie, the user may invoke one of various trick plays such as, for example, fast forwarding, rewinding, pausing, and the like. A description of how such trick plays are handled by the server is described in further detail in the U.S. patent application entitled “Improved Media Transfer Protocol.” During such trick plays, the server may transmit to the client an overlay image of an icon depicting the trick play, and a status bar which indicates the current position in the video in relation,to the entire video.

The user may invoke the main UI menu again by pressing, for example, a menu button on the input device 412. If the user selects the music option, the media server 100 generates an updated UI with a list of albums/artists, and associated album covers or generic icons. The updated UI is transformed into a video format and transmitted to the client for display thereon. The UI may allow the user to search his or her music files by artist, song, rating, genre, and the like. The media server 100 searches the metadata stored in the media database 106 upon receipt of such a search request, and presents an updated UI including the searched information.

According to one embodiment of the invention, the media server generates and transmits a UI with a list of songs contained in a selected album. The user may navigate to a particular song listing and hit a “play” button to listen to the music. The selected music is retrieved by the media server 100 and streamed to the client for playing in real time. According to one embodiment of the invention, information associated with the current song, such as, for example, the song and album name, artist, and genre information may also be retrieved from the media database 106 and transmitted to the client for display while the music is being played. A list of other songs in the album may also be concurrently displayed for allowing the user to skip to a next song if desired.

According to one embodiment of the invention, the user may navigate to the photos option while a previously selected music is playing in the background. Upon navigating to the photos option, the media server 200 generates an updated UI with a list of photo files stored in the media database 106 which are organized, for example, by year, month, and day. The updated UI may also include thumbnails of the various photos. The updated UI is transformed into a video format and transmitted to the client for display. Selection of a particular thumbnail causes the selected photo to be displayed in an enlarged format.

According to one embodiment of the invention, navigation icons associated with media being transmitted by the media server 100 may be displayed on the client 102 as image overlay data. For example, if background music is being played in association with a slide show, the client may display the name of the song that is being played as well as music navigation icons which allow the user to skip to a next or previous song, or pause and stop the current song. Navigation icons associated with the slide show may also be displayed in addition or in lieu of the music navigation icons. The navigation icons associated with the slide show may allow the user to skip forward or backward in the slide show, change the timing in-between pictures, and the like. The user may control the type of overlay information, if any, that is to be displayed by the client 102.

According to one embodiment of the invention, the services option provides to the user various video on demand services including browsing online media listings, purchasing or renting movies, purchasing tickets, exchanging keys for playing media files protected by a digital rights management (DRM) key, and the like. The user may also browse web pages, obtain news, manage stocks, receive weather updates, and play games via the services option. The UI associated with these services may be generated by the media server 100, or obtained by the media server from one of various online service providers 112 or web servers 116. The media server encodes the associated UI into a compressed video format, and streams the video to the client for display. All interactions with the UI are received by the media server 100 and may be forwarded to the appropriate online service provider 112 and/or web server 116 for processing.

For example, if the user selects to browse the Internet, the user provides the address of a particular web page that is to be retrieved and transmits the information to the media server 100 in a UI event packet. The media server 100 retrieves address from the UI event packet and forwards the address to the web server 116 for processing. The web server 116 retrieves a web page associated with the received address, and forwards the web page to the media server 100.

The media server 100 receives the web page and identifies the selectable portions of the web page based, for example, on information encoded into the web page. The media server 100 then generates a linear list of the selectable portions and dynamically builds a state machine for transitioning from one selectable portion of the web page to another based on specific button presses or other types of user input. For example, each selection of a “next object” button press may cause transitioning to the next selectable portion in the linear list.

The media server then transforms a currently received web page into a compressed video format, and streams the compressed video to the client over the video connection. In this regard, the network transport module 302 generates a UI transfer object 314 (FIG. 3) which encodes and compresses the web page into one or more compressed video frames, such as, for example, DivX video frames. The compressed video frames are then streamed to the client in a UI mode. If the web page is a “still” web page, a single video frame is streamed to the client and the client plays the same video frame over and over at an indicated frame rate until the web page is updated.

A user uses the input device 412 coupled to the client to interact with the web page. The client packages the user interactions as UI event packets 202, and transfers the packets to the server 100. The server examines the event packets for determining the type of user interaction, and maps the user interaction to a particular selectable portion of the web page. For example, if the selectable portion includes a hyperlink, the hyperlink selection information is forwarded to the web server 116 for processing. The web server 116 retrieves a web page based on the hyperlink information and forwards the web page to the server. The server receives the forwarded web page, transforms it into a compressed video format, and forwards the compressed video to the client.

According to another example, the user selects to play a game from the services option. In response, the media server 100 generates an updated UI with a list of games and/or game icons. The updated UI is transformed into a compressed video format and transmitted to the client for display thereon. The UI may allow the user to search the list of games by, for example, game name. The media server 100 searches the metadata stored in the media database 106 upon receipt of such a search request, and presents an updated UI including the searched information.

The user may navigate to a particular game and hit an “enter” or “play” button to play the game. The selected game is retrieved by the media server 100, transformed into a compressed video format, and streamed to the client over the video connection. In this regard, the network transport module 302 generates a UI transfer object 314 (FIG. 3) which encodes the computer graphic images of the computer game scenes into compressed video frames, such as, for example, DivX video frames. The compressed video frames are then streamed to the client in a UI mode. As a user uses the input device 412 coupled to the client to play the game, the client packages the user interactions as UI event packets 202 which are transferred to the server 100 over a separate control channel for processing by the server. The server generates updated video streams based on the user interactions and streams the updated video streams to the client.

According to one embodiment of the invention, the media server provides other kinds of applications which are run locally at the media server and transmitted to the client as a UI stream. The user then remotely interfaces with the application via the client. All user interactions, however, are processed by the media server, and updated images and/or audio are transmitted to the client as updated UI video and/or audio in response. The applications may be customized non-HTML applications such as, for example, an interactive map application similar to Google Earth, or a slideshow viewer similar to the Flicker photo slideshow.

Another exemplary application is a karaoke application providing audio/visual karaoke content to the client. The visual content is encoded into a compressed video format and transmitted over the dedicated video connection. The audio content is transmitted over the dedicated audio connection. Alternatively, the media server could retrieve mp3 music stored in the media database 106 and stream the music over the dedicated audio channel, while the lyrics could be obtained from a website and encoded into a compressed video format and transmitted over the dedicated video connection.

According to one embodiment of the invention, the media server also functions as a multi-tasking operating system for the client. According to this embodiment, the media server swaps in and out of particular UI applications responsive to user actions. For example, the user may select a particular media player UI application to cause the selected application to the provided to the client. The UI application may, for example, display an audio playlist. A particular audio selected from the playlist may then be streamed over the dedicated audio connection. In another example, the UI application may be a photo slideshow application providing a photo slideshow over the dedicated video channel. The media player application's audio stream may be transmitted over a dedicated audio channel for being played in the background. The user may press a particular key, such as, for example, and exit key, to swap a current UI application out, and return to the menu of UI applications.

According to one embodiment of the invention, the media server also supports concurrent applications. For example, video from an interactive map application such as Google Earth may be rendered at the same time as audio from a music application, such as a Yahoo Music Engine application.

According to one embodiment of the invention, the media server 100 may transmit to the client 102 media encrypted with a DRM key. If the client is an authorized client, it is provided with the necessary decryption keys in order to play the encrypted media file. The decryption keys may be obtained upon registration of the CE device as an authorized player of the encrypted media content. For example, a user may access the media server 100 to access a registration server and enter a registration number provided with the CE device. In response, the registration server transmits to the media server an activation file which the user burns to a CD. Alternatively, the activation file may be streamed over the improved media transfer protocol described in the above-referenced application entitled “Improved Media Transfer Protocol.” According to one embodiment, the activation file includes a registration code, a user ID, and a user key. Upon playback of the CD on the client CE device, the CE device checks the registration code burned onto the CD against the registration code stored inside the CE device. Upon a match, the CE device loads the user ID and user key into its local memory and uses them to decode and play the DRM-protected media.

According to another embodiment of the invention, the user's password and username are entered and stored into the CE device. Upon receipt of a DRM-protected media, the CE device transmits a command to the media server 100 to contact a remote server with the username and password. Upon authentication of the user based on the transmitted username and password, the remote server provides a key to the media server 100 which is then forwarded to the CE device for use to play the DRM-protected content.

Additional details on how the CE device may decode and play DRM-protected data is described in further detail in U.S. patent application Ser. No. 10/895,355 entitled “Optimized Secure Media Playback Control,” filed on Jul. 21, 2004, the content of which is incorporated herein by reference.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

1. A method for a remote user interface in a data communications network including a client device coupled to a server, the method comprising:
retrieving a first graphics-based image from a data store;
encoding the first graphics-based image into a compressed video frame;
streaming the compressed video frame to the client device, the client device being configured to uncompress and play the video frame;
receiving a control event from the client device; and
retrieving a second graphics-based image from the data store based on the received control event.

2. The method of claim 1, wherein the graphics-based image is an interactive menu page, and the control event is a user selection of a menu item on the menu page.

3. The method of claim 1, wherein the graphics-based image is an interactive computer game scene, and the control event is a user selection of a game object in the computer game scene.

4. The method of claim 1, wherein the graphics-based image is an interactive web page, and the control event is a user selection of a link on the web page.

5. The method of claim 1, wherein the compressed video frame is streamed over a dedicated video transfer channel and the control event is received over a dedicated control channel.

6. The method of claim 1 further comprising:
updating the first graphics-based image based on the control event; and
storing the updated first graphics-based image in the data store as the second graphics-based image.

7. A method for a remote user interface in a data communications network including a client device coupled to a server, the method comprising:
decoding and uncompressing one or more compressed first video frames received from the server;
playing first video contained in the one or more first video frames, the first video providing one or more user interface images;
receiving user input data responsive to the one or more user interface images;
generating a control event based on the user input data;
transmitting the control event to the server; and
receiving from the server one or more compressed second video frames responsive to the transmitted control event, the one or more compressed second video frames containing updated one or more user interface images.

8. The method of claim 7, wherein the one or more user interface images are images of interactive menu pages, and the user input data is for a user selection of a menu item on a particular menu page.

9. The method of claim 7, wherein the graphics-based image is an interactive computer game scene, and the user input data is for a user selection of a game object in the computer game scene.

10. The method of claim 7, wherein the graphics-based image is an interactive web page, and the user input data is for a user selection of a link on the web page.

11. The method of claim 7, wherein the one or more compressed first and second video frames are received over a dedicated video transfer channel and the control event is transmitted over a dedicated control channel.

12. A server providing a remote user interface on a client device coupled to the server over a wired or wireless data communications network, the server comprising:
a frame buffer storing a first graphics-based image;
a video encoder encoding the first graphics-based image into a compressed video frame; and
a processor coupled to the video encoder and the frame buffer, the processor streaming the compressed video frame to the client device, the client device being configured to uncompress and play the video frame, the processor further receiving a control event from the client device and retrieving a second graphics-based image from the frame buffer based on the received control event.

13. The server of claim 12, wherein the graphics-based image is an interactive menu page, and the control event is a user selection of a menu item on the menu page.

14. The server of claim 12, wherein the graphics-based image is an interactive computer game scene, and the control event is a user selection of a game object in the computer game scene.

15. The server of claim 12, wherein the graphics-based image is an interactive web page, and the control event is a user selection of a link on the web page.

16. The server of claim 12 further comprising:
a dedicated video transfer channel interface for streaming the compressed video frame to the client device; and
a dedicated control channel interface for receiving the control event from the client device.

17. The server of claim 12 further comprising:
a graphics processing unit coupled to the frame buffer generating the first graphics-based image.

18. The server of claim 17, wherein the graphics processing unit updates the first graphics-based image based on the control event and stores the updated first graphics-based image in the frame buffer as the second graphics-based image.

19. A client device coupled to the server over a wired or wireless data communications network for providing a user interface, the client device comprising:
a video decoder decoding and uncompressing one or more compressed first video frames received from the server;
a display coupled to the video decoder for displaying first video contained in the one or more first video frames, the first video providing one or more user interface images;
a user input providing user input data responsive to the one or more user interface images; and
a processor coupled to the user input for generating a control event based on the user input data and transmitting the control event to the server, the processor receiving from the server one or more compressed second video frames containing updated one or more user interface images.

20. The client device of claim 21, wherein the one or more user interface images are images of interactive menu pages, and the user input data is for a user selection of a menu item on a particular menu page.

21. The client device of claim 21, wherein the graphics-based image is an interactive computer game scene, and the user input data is for a user selection of a game object in the computer game scene.

22. The client device of claim 21, wherein the graphics-based image is an interactive web page, and the user input data is for a user selection of a link on the web page.

23. The client device of claim 21 further comprising:
a dedicated video transfer channel interface for receiving the one or more compressed first and second video frames; and
a dedicated control channel interface for transmitting the control event.

24. The client device of claim 21, wherein the dedicated video transfer channel interface receives media encrypted with an encryption key, the client device further comprising means for obtaining a decryption key for decrypting and playing the encrypted media.
